(19) United States
(12) Patent Application Publication
(10) Pub. No.: US 2012/0318851 A1
(43) Pub. Date: Dec. 20, 2012

(54) CHIP BONDING PROCESS

(75) Inventors: Wei-Cheng LOU, Taoyuan County (TW); Ming-Tang Chen, Taoyuan County (TW); Ting-Yu Chou, Taoyuan County (TW); Jung-Kun Wu, Taoyuan County (TW); Chung-l Chiang, Taoyuan County (TW)

(73) Assignee: WALSIN LIHWA CORPORATION, Taoyuan (TW)

(21) Appl. No.: 13/280,497

(22) Filed: Oct. 25, 2011

(30) Foreign Application Priority Data
Jun. 20, 2011 (TW) 100121501

(51) Int. Cl. B23K 31/02

(52) U.S. Cl. 228/179.1

(57) ABSTRACT

A chip bonding process includes the following steps. At least one chip is transferred onto a carrier, and a negative pressure environment is provided. Heat is provided to the at least one chip and/or the carrier, and a positive pressure is applied onto the at least one chip.

This application claims the benefit of Taiwan application Serial No. 100121501, filed Jun. 20, 2011, the subject matter of which is incorporated herein by reference.

### BACKGROUND OF THE INVENTION

1. Field of the Invention

The invention relates in general to a chip bonding process, and more particularly to a chip bonding process for performing alignment, increasing pressure and providing heat to a chip.

2. Description of the Related Art

Chip bonding is an important process in the manufacturing of a semiconductor. After a wafer cutting process, chips are removed and bonded on a carrier for subsequent process such as wire bonding and chip packaging. Also, after the chip bonding process is completed, the chips must be baked in order to solidify the viscose, and the carrier with chips bonded thereon is placed and baked in an oven. According to an eutectic chip bonding process, heat is provided to the carrier end and/or the chip end for heating two metal layers to an eutectic temperature, so that the two metal layers are bonded together, the energy barrier in metal linking is overcome, and the chips are bonded onto the carrier. However, when the heating area on the carrier is too large, too much heat would be accumulated on the non-bonding area due to continuous heating, and thus bad thermal effect will occur. On the other hand, when the heating area is too small or when heat is provided only to a local area, the chips will not be heated unless the chips enter the bonding area, and the waiting time certainly causes production efficiency to deteriorate.

In addition, temperature control is another important issue. Since the eutectic chip bonder bonds the chips onto the carrier one by one, production efficiency is poor. Meanwhile, the chips may even be damaged and the performance of the chips may even be jeopardized if the magnitude and distribution of the force applied by the bonding head are not under suitable control. Also, if the temperature in the bonding area needs to be increased to a predetermined temperature during the process of bonding a single chip, the temperature needs to be precisely controlled. Moreover, both the area with chips bonded thereto and the area without any chips which have been heated continuously would accumulate too much heat. Consequently, this induces some harmful thermal effects, and subsequent manufacturing process is affected.

### SUMMARY OF THE INVENTION

The invention is directed to a chip bonding process, in which the chip transportation device, the ventilation device and the heating device are combined for picking, placing and aligning a chip, and a mechanic normal force or an air normal force is applied onto at least one chip. Since heat is concurrently provided to the chips of the same batch and the carrier, thermal accumulation is reduced, the chips are protected and production efficiency is increased.

According to an aspect of the present invention, a chip bonding process including the following steps is provided. At least one chip is transferred onto a carrier and a negative pressure environment is provided. Heat is provided to the at least one chip and/or the carrier and a positive pressure is applied onto the at least one chip.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A and FIG. 1B respectively show a schematic diagram of a chip bonding apparatus and a schematic diagram of the interior of a chamber according to an embodiment of the invention; and

FIG. 2 shows a flowchart of a chip bonding process according to an embodiment of the invention.

### DETAILED DESCRIPTION OF THE INVENTION

The chip bonding apparatus and process disclosed in the present embodiment of the invention include a chip picking and placing system (such as a picker), an alignment system (such as an alignment device) for bonding a chip onto a carrier, a chamber exhaust and intake system (referred as ventilation device hereinafter), an adjustment system (such as a pump or a chip bonding head) for applying a mechanic pressure or a gas pressure onto the chip, and a chamber heating and temperature control system (referred as heating device hereinafter). The chip bonding apparatus of the present embodiment picks several chips concurrently by a plurality of pickers, and then transfers the chips onto the carrier. Then, each chip is positioned and placed on a corresponding position on the carrier by the alignment device for bonding the chips of the same batch onto the carrier. The heating device (such as furnace), placed in a chamber, provides heat to the chips of the same batch and the carrier either individually or concurrently so that the heat will not be accumulated in different bonding areas. Moreover, when heat is provided to the at least one chip and/or the carrier, the chip bonding head or the ventilation device applies a mechanic pressure, a gas pressure or a combination thereof above the chips for uniformly distributing the gas over the chips, so that the chips will be protected and will not be damaged. The chip bonding apparatus and process disclosed above can be used for bonding an LED chip onto a carrier, which can be realized by such as a lead frame, a glass substrate, a printed circuit board or a metal substrate, and no specific restriction is applied to the carrier.

A number of embodiments are disclosed below for detailed descriptions of the invention only, not for limiting the scope of protection of the invention.

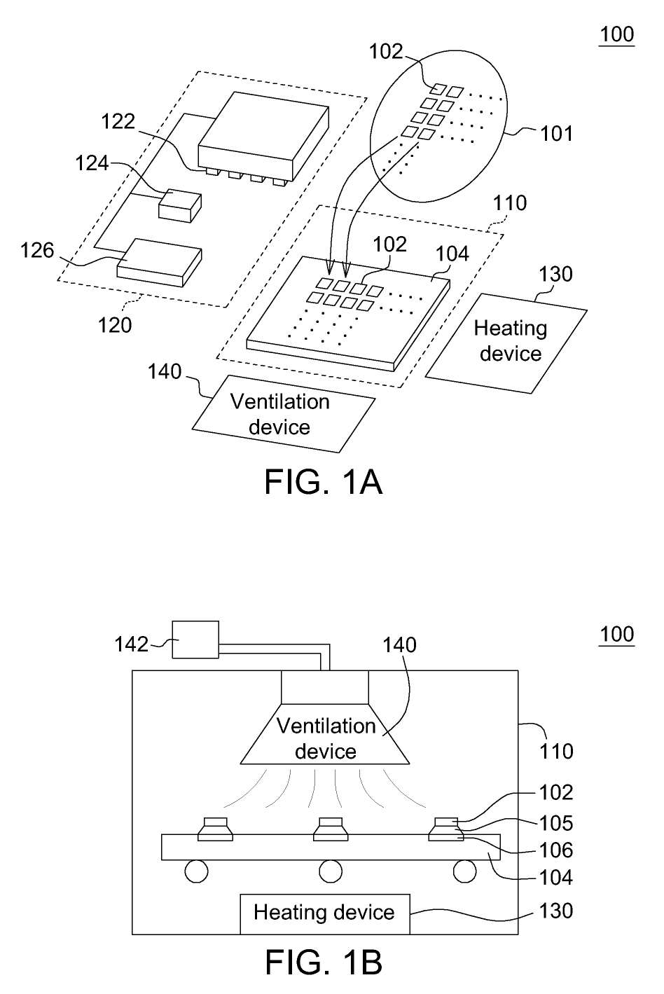

Referring to FIGS. 1A and 1B, a schematic diagram of a chip bonding apparatus and a schematic diagram of the interior of a chamber according to an embodiment of the invention are respectively shown. The chip bonding apparatus 100 includes a chamber 110, a chip transportation device 120, a heating device 130 and a ventilation device 140. The chip transportation device 120 is used for transferring at least one chip 102 onto a carrier 104 within the chamber 110. The heating device 130 is used for providing heat to the at least one chip 102 and/or the carrier 104 within the chamber 110. The ventilation device 140 communicates the gas to flow through the chamber 110 to form a negative pressure environment within the chamber 110, or provides a positive pressure onto the at least one chip 102.

To put it in greater details, the chip transportation device 120 includes several pickers 122, which concurrently pick several chips 102 obtained after the wafer 101 is cut and further transfer the chips onto the carrier 104 for the subsequent alignment process. Besides, the chip transportation device 120 further includes an alignment device 124 which aligns and transfers the chips 102 onto the carrier 104 for bonding the chips 102 of the same batch onto the carrier 104. The present embodiment is different from the conventional method in that during the process of alignment, temperature is not increased, and pressure is not applied onto the chips 102. In the conventional method, an eutectic chip bonder is used for bonding the chips one by one, but the bonding cannot start unless the interface metal is heated to achieve a liquid state or a temperature higher than the eutectic temperature.

In the present embodiment of the invention, prior to the alignment process, an interface metal 105 (such as a solder or gold-tin alloy) is coated onto the carrier 104 to remove oxidization and assist the bonding of the chips 102. Then, the alignment device 124 concurrently place several chips 102 on corresponding bonding pads 106 disposed on the carrier 104. Meanwhile, no pressure is applied and the temperature is not increased (such as at room temperature and an atmospheric pressure), and production efficiency can thus be increased.

Besides, when the chip transportation device 120 transfers at least one chip 102 onto the carrier 104 within the chamber 110, the ventilation device 140 provides a negative pressure environment within the chamber 110. In the negative pressure environment, the atmospheric pressure is such as smaller than 1, or very small (such as 0.1 torr) or near vacuum. In the present embodiment of the invention, the ventilation device 140 includes a pump 142, which communicates gas to flow through the chamber 110 for vacuuming the gas off the chamber 110 to form a negative pressure environment.

Then, when the chips 102 and the carrier 104 are aligned in a negative pressure environment, no matter the interface metal 105 is a gold-tin alloy or is a gold layer and a tin layer respectively plated on the bonding pad 106, heat can be provided to the carrier 104 alone or to both the carrier 104 and the chip 102 for heating the interface metal 105 to a liquid state or an eutectic temperature. In the present embodiment, the heating device 130 may include a furnace used for heating the at least one chip 102 and/or the carrier 104 to 150° C. above. For example, if the interface metal 105 is formed by a tin-lead alloy, the eutectic temperature needs to be over 180° C. If the interface metal 105 is formed by a gold-tin alloy, then the eutectic temperature needs to be higher than 200° C.

The heating device 130 provides heat to the chips 102 of the same batch and the carrier 104 concurrently so that the heat will not be accumulated in different bonding areas. During the heating process, the chip bonding apparatus 100 further includes a chip bonding head 126, which generates a mechanic force on the at least one chip 102 for bonding the at least one chip 102 onto the carrier 104 by way of thermal compression.

When heating is provided to the at least one chip 102 and/or the carrier 104, the ventilation device 140 can apply a positive pressure onto the at least one chip 102. For example, if the pump 142 no more vacuums the gas off the chamber 110 after having provided an negative pressure environment required in the alignment process, the pump 142 can further provide an inert gas such as nitrogen, argon through the inlet to form a positive pressure onto the at least one chip 102 to protect the at least one chip 102.

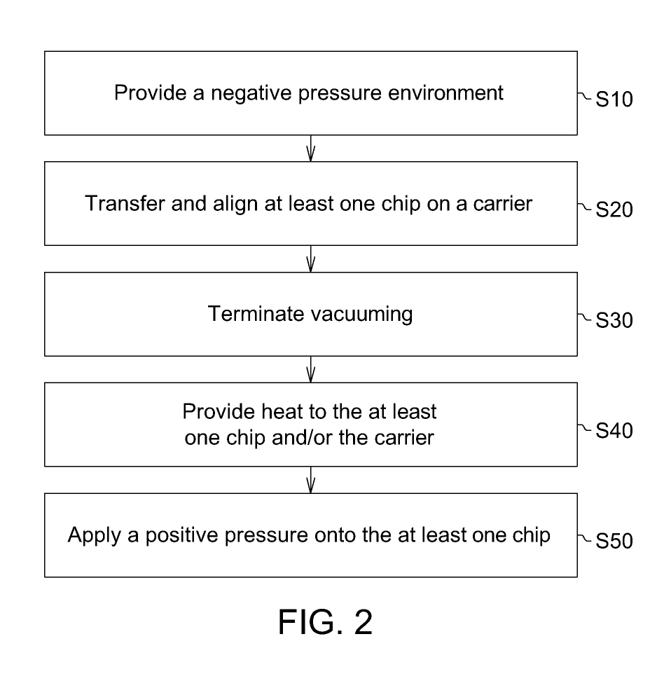

Referring to FIG. 2, a flowchart of a chip bonding process according to an embodiment of the invention is shown. In step S10, a negative pressure environment is provided. In step S20, at least one chip is transferred onto a carrier and the at least one chip is aligned on the carrier. In step S30, vacuuming is terminated. In step S40, heat is provided to the at least one chip and/or the carrier. In step S50, a positive pressure is applied onto the at least one chip. In FIG. 2, the chips are transferred after a negative pressure environment is provided, but in another embodiment, the chips can be transferred before the negative pressure environment is provided, and then the chips are aligned in sequence in the negative pressure environment.

Steps S10˜S50 of FIG. 2 are elaborated with the chip bonding apparatus 100 of FIGS. 1A and 1B. Referring to FIGS. 1A and 1B and FIG. 2, when the chip transportation device 120 transfers at least one chip 102 onto the carrier 104 within the chamber 110, the ventilation device 140 provides a negative pressure environment within the chamber 110 for performing steps S10 and S20. The chip transportation device 120 includes several pickers 122 and an alignment device 124, wherein the pickers 122 can concurrently pick several chips 102 and transfer the chips onto the carrier 104. Then, the chips are aligned by the alignment device 124 in sequence. The carrier 104 further includes at least one bonding pad 106, which provides alignment for the alignment device 124, so that the pickers 122 can place the chips 102 on corresponding bonding pads 106. The above step of transferring the chips 102 is performed at room temperature.

In addition, the ventilation device 140 includes a pump 142, which communicates gas to flow through the chamber 110 and vacuums the gas off the chamber 110 to form a negative pressure environment therein. In step S30, when the ventilation device 140 terminates vacuuming the gas, the pump 142 could further provide an inert gas to form a positive pressure onto the at least one chip 102 for performing step S50.

In step S50, besides providing an air normal force, the chip bonding apparatus 100 further includes a chip bonding head 126 which generates a mechanic normal force on the at least one chip 102 for bonding the at least one chip 102 onto the carrier 104 by way of thermal compression.

In step S40, the heating device 130 is used to provide heat to the at least one chip 102 and/or the carrier 104 within the chamber 110. In an embodiment, step S40 includes heating the at least one chip 102 and/or the carrier 104 to a temperature higher than 150° C. so that the interface metal 105 can be heated to a temperature higher than the eutectic temperature.

According to the chip bonding apparatus and process disclosed in the above embodiments of the invention, the chip transportation device, the ventilation device and the heating device are combined for picking, placing and aligning at least one chip, and a mechanic normal force or an air normal force is applied onto at least one chip, not only concurrently providing heat to the chips of the same batch and the carrier to reduce thermal accumulation, but also protecting the chip and increasing production efficiency.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A chip bonding process, comprising:
providing a negative pressure environment;
transferring at least one chip onto a carrier in the negative pressure environment, wherein the at least one chi in the negative pressure environment is free of positive pressure and the temperature of the at least one chip is kept at room temperature; and
heating the at least one chip and/or the carrier and applying a positive pressure onto the at least one chip.

2. The chip bonding process according to claim 1, wherein the step of providing the negative pressure environment further comprises providing an environment having a pressure smaller than 1 atmosphere.

3. The chip bonding process according to claim 1, wherein the step of transferring the at least one chip onto the carrier further comprises a step of aligning the at least one chip on the carrier.

4. The chip bonding process according to claim 1, wherein the heating step comprises heating the at least one chip and/or the carrier to a temperature higher than 150° C.

5. The chip bonding process according to claim 1, wherein the step of applying the positive pressure comprises providing a mechanical normal force or an air normal force.

6. The chip bonding process according to claim 5, wherein the step of providing the air normal force comprises providing a gas onto the at least one chip.

7. The chip bonding process according to claim 6, wherein the step of providing the gas comprises providing an inert gas.

8. The chip bonding process according to claim 1, further comprising providing at least one bonding pad onto the carrier.

9. A chip bonding process, comprising:
providing a negative pressure environment and concurrently transferring a plurality of chips onto a carrier in the negative pressure environment; and
heating the chips and/or the carrier and applying a positive pressure onto the chips;
wherein, the chips in the negative pressure environment are free of positive pressure and the temperature of the chips is kept at room temperature at the step of transferring the chips onto the carrier.

10. The chip bonding process according to claim 9, further comprising a step of aligning the chips on the carrier.

11. The chip bonding process according to claim 10, wherein prior to the step of heating the chips and/or the carrier and the step of applying a positive pressure onto the chips, the step of providing a negative pressure environment is performed.

12. The chip bonding process according to claim 9, wherein prior to the step of heating the chips and/or the carrier and the step of applying a positive pressure onto the chips, the step of providing a negative pressure environment is performed.
